(19) United States
(12) Patent Application Publication
(10) Pub. No.: US 2006/0074743 A1
(43) Pub. Date: Apr. 6, 2006

(54) System and method for appraising job performance

(75) Inventors: Michael L. Brown, Waxahachie, TX (US); Robert J. Landis, Midlothian, TX (US)

Correspondence Address: DOCKET CLERK, P.O. DRAWER 800889, DALLAS, TX, 75380, US

(73) Assignee: SkillsNET Corporation, Waxahachie, TX (US)

(21) Appl. No.: 11/237,617

(22) Filed: Sep. 28, 2005

Related U.S. Application Data
(60) Provisional application No. 60/614,088, filed on Sep. 29, 2004.

(51) Int. Cl. G06F 11/34

(52) U.S. Cl. 705/11

(57) ABSTRACT

At least one work activity associated with an employee's job is identified. The employee identifies at least one additional work activity. At least one task for each of the identified work activities is identified. The employee identifies at least one additional task for one or more of the identified work activities. The employee assigns a rating to each of the identified tasks. The ratings are associated with the employee's performance of the identified tasks.

### CROSS-REFERENCE TO RELATED APPLICATIONS

This application claims priority under 35 U.S.C. § 119(e) to U.S. Provisional Patent Application No. 60/614,088 filed on Sep. 29, 2004, which is hereby incorporated by reference.

### TECHNICAL FIELD

This disclosure relates generally to human resource management systems and more specifically to a system and method for appraising job performance.

### BACKGROUND

Employers often perform annual performance reviews to evaluate the quality and competency of their employees. However, performance reviews often suffer from several drawbacks. For example, a lack of standardized performance reviews typically means that managers review employees differently, even when the employees perform similar tasks. Also, employees with identical job titles may perform widely different tasks, making it difficult to compare employee performance. Among other things, these problems often make it difficult to identify employees who are suitable for promotion.

### SUMMARY

This disclosure provides an improved system and method for appraising job performance.

In one aspect, a method includes identifying at least one work activity associated with an employee's job and allowing the employee to identify at least one additional work activity. The method also includes identifying at least one task for each of the identified work activities and allowing the employee to identify at least one additional task for one or more of the identified work activities. In addition, the method includes allowing the employee to assign a rating to each of the identified tasks. The ratings are associated with the employee's performance of the identified tasks.

In a particular aspect, the method identifies up to seven work activities, and the employee is allowed to identify up to three additional work activities. In another particular aspect, the method identifies up to ten tasks for each of the identified work activities, and the employee is allowed to identify up to five additional tasks for each of the identified work activities.

Other technical features may be readily apparent to one skilled in the art from the following figures, descriptions, and claims.

### BRIEF DESCRIPTION OF DRAWINGS

For a more complete understanding of this disclosure, reference is now made to the following description, taken in conjunction with the accompanying drawings, in which:

FIG. 1 illustrates an example system for appraising job performance according to one embodiment of this disclosure;

FIG. 2 illustrates an example form used to evaluate overall performance of a work activity according to one embodiment of this disclosure;

FIG. 3 illustrates an example method for appraising job performance according to one embodiment of this disclosure; and

FIG. 4 illustrates an example method for performing an employee self-appraisal according to one embodiment of this disclosure.

### DETAILED DESCRIPTION OF EXAMPLE EMBODIMENTS

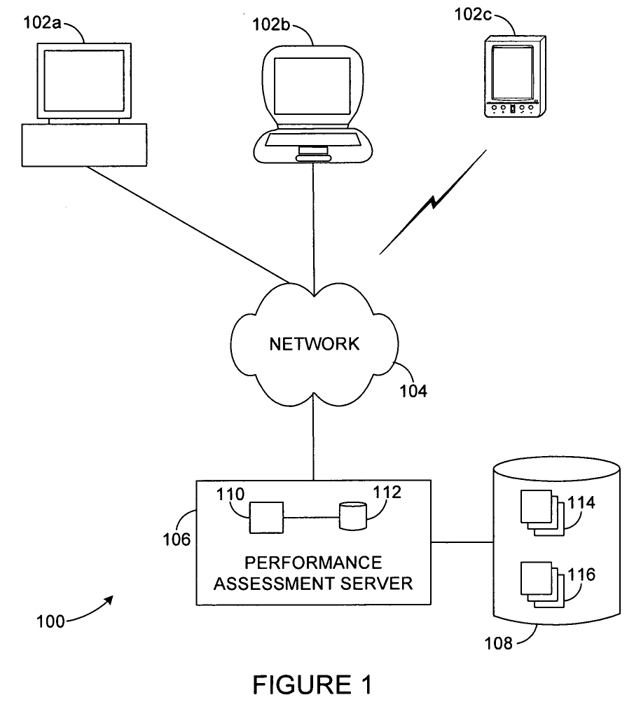

FIG. 1 illustrates an example system 100 for appraising job performance according to one embodiment of this disclosure. In the illustrated example, the system 100 includes multiple user devices 102a-102c, a network 104, a performance assessment server 106, and a database 108. Other embodiments of the system 100 may be used without departing from the scope of this disclosure.

In one aspect of operation, an employee uses one of the user devices 102a-102c (referred to as “user devices 102”) to access the performance assessment server 106. The performance assessment server 106, among other things, allows the employee to identify goals for a future time period (such as three months). The performance assessment server 106 also allows the employee to evaluate the employee's goals for a prior time period. The performance assessment server 106 further allows the employee to perform a self-evaluation, such as an annual self-evaluation, by allowing the user to select some of the activities and tasks evaluated. In addition, the performance assessment server 106 allows a supervisor to evaluate the employee using the information provided by the employee. In this way, the performance assessment server 106 supports more standardized performance reviews that are based at least partially on the tasks performed by employees.

In the illustrated embodiment, each user device 102 is capable of communicating with the network 104. In this document, the term “each” refers to each of at least a subset of the identified items. Each user device 102 represents any suitable device, system, or portion thereof that allows a user to communicate and interact with the performance assessment server 106. For example, a user device 102 allows an employee to access the performance assessment server 106 and perform an annual self-evaluation. A user device 102 also allows a supervisor to access the information provided to the performance assessment server 106 by the employee and to perform a supervisory evaluation of the employee.

In this particular example, the user devices 102 include a desktop computer, a laptop computer, and a personal digital assistant. Each of these user devices 102 communicates over a wireline or wireless connection. These user devices 102 are for illustration only. Any other or additional computing or communication devices may be used in the system 100. Each user device 102 includes any hardware, software, firmware, or combination thereof for accessing the performance assessment server 106.

The network 104 is capable of communicating with the user devices 102 and the performance assessment server 106. The network 104 facilitates communication between components of the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

The performance assessment server 106 is coupled to the network 104 and the database 108. In this document, the term “couple” and its derivatives refer to any direct or indirect communication between two or more elements, whether or not those elements are in physical contact with one another. The performance assessment server 106 supports the assessment of employees by the employees and the employees' supervisors. For example, the performance assessment server 106 may facilitate employee self-evaluations and supervisory evaluations of the employees. As particular examples, the performance assessment server 106 may actually receive information provided before, during, or after employee self-evaluations and supervisory evaluations or provide forms for use during the evaluations.

The performance assessment server 106 includes any hardware, software, firmware, or combination thereof for performing or otherwise supporting a performance evaluation. As a particular example, the performance assessment server 106 could include one or more processors 110 and one or more memories 112 containing data and instructions used by the one or more processors 110. Also, the performance assessment server 106 may receive input from the users in any suitable manner, such as through the use of a web-based interface.

The database 108 is coupled to the performance assessment server 106. The database 108 stores various information used by the performance assessment server 106 to provide or otherwise support a performance evaluation. For example, jobs are typically associated with one or more general work activities, where each work activity is associated with one or more tasks. In some embodiments, the database 108 identifies multiple work activities 114 and tasks 116. In particular embodiments, each work activity 114 is associated with one or more of the tasks 116. Each job for which performance may be assessed is associated with one or more of the work activities 114, and each of those work activities 114 is associated one or more of the tasks 116.

In these embodiments, during an employee self-evaluation, the performance assessment server 106 allows an employee to evaluate his or her performance of the various tasks 116 for the work activities 114 associated with the employee's job. In some embodiments, the employee evaluates at least one default or preassigned task 116 for at least one work activity 114 associated with the employee's job. The employee is also given the option of selecting one or more work activities 114 to be evaluated by the employee during the self-assessment. Similarly, the employee is also given the option of selecting one or more tasks 116 for each work activity 114 to be evaluated by the employee during the self-assessment. By allowing the employee to select one or more work activities 114 and/or tasks 116 for evaluation during a self-assessment, the employee may tailor the self-assessment to the employee's actual job functions.

In particular embodiments, tasks 116 associated with seven default work activities 114 are reviewed by an employee during a self-assessment, and the employee is allowed to select up to three additional work activities 114. Also, each work activity 114 reviewed during a self-assessment has ten default tasks 116 associated with it, and the employee is allowed to select up to five more tasks 116 for each work activity 114. In addition, the employee evaluates or rates each task using a scale, such as a scale of values ranging from one (low) to five (high).

After the employee has performed the self-assessment, the performance assessment server 106 generates a score for each work activity 114 that was assessed. In some embodiments, the performance assessment server 106 calculates a score for a work activity 114 by averaging the ratings for all evaluated tasks 116 associated with that work activity 114.

Similarly, during the evaluation of an employee by a supervisor, the supervisor may review the employee's quarterly reports (establishing goals and reviewing prior goals). The supervisor then rates the employee's performance of tasks 116 for work activities 114 that the supervisor has observed.

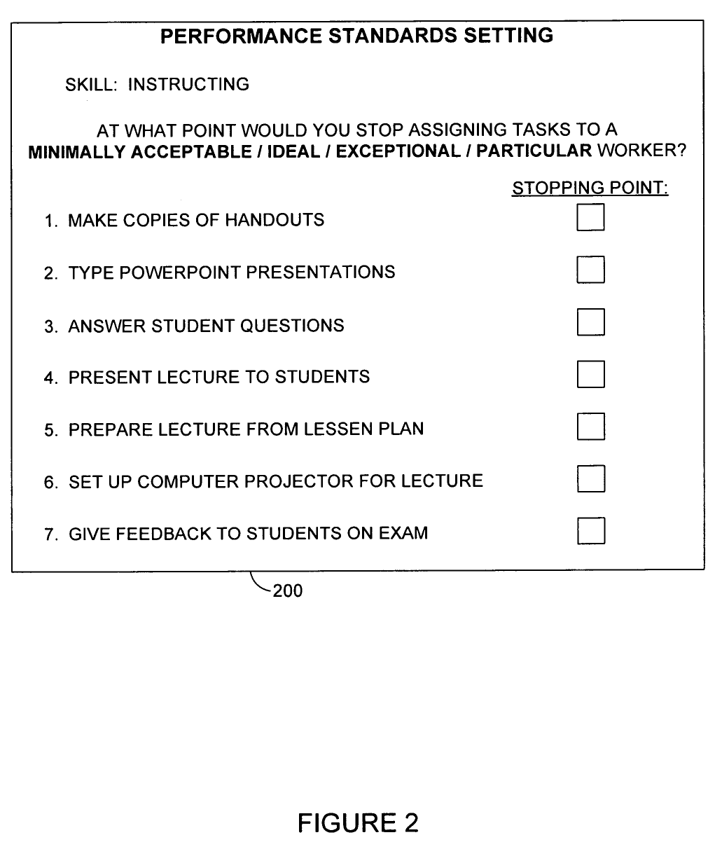

In addition, the supervisor rates the employee's overall performance of each work activity 114 observed. For example, the supervisor may be asked to identify whether the employee must be taught before a task can be completed, whether a task requires some instruction before completion, whether a task may or may not require instruction before completion, whether a task is completed with little or no supervision, and whether a task is completed with no supervision needed. As another example, the supervisor may be asked to identify when the supervisor would stop assigning tasks to the employee, such as by using a form shown in FIG. 2, which is described below.

Once the employee has performed a self-evaluation and the supervisor has performed an evaluation, the supervisor provides feedback to the employee. The feedback may include an explanation of the performance appraisal, how it can be used, and how the appraisal process is based on the selected work activities 114 and tasks 116. The feedback may also include the appraisal results. In addition, the feedback may include a discussion of the options available to the employee if the employee objects to the appraisal results.

Although FIG. 1 illustrates one example of a system 100 for appraising job performance, various changes may be made to FIG. 1. For example, the system 100 may include any number of user devices 102, networks 104, servers 106, and databases 108. Also, although the description above has described the use of a server 106 in the system 100, the functionality of the server 106 could be implemented on other computing device(s), such as a desktop computer or a laptop computer. In addition, while FIG. 1 illustrates that one database 108 is coupled directly to the interview support server 106, any number of databases 108 may reside at any location or locations accessible by the server 106.

FIG. 2 illustrates an example form 200 used to evaluate overall performance of a work activity according to one embodiment of this disclosure. The form 200 shown in FIG. 2 is for illustration only. Other mechanisms may be used to rate an employee's performance of a work activity 114 without departing from the scope of this disclosure.

As shown in FIG. 2, the form 200 identifies seven tasks ranked in order of increasing perceived difficulty. In this example, a supervisor uses the form 200 to identify the point at which the supervisor would stop assigning tasks to a minimally acceptable employee, an ideal employee, an exceptional employee, or a particular employee.

A score for the identified employee or type of employee may be calculated using the form 200 in any suitable manner. For example, the score could be identified using the number assigned to the selected task in the form 200. As another example, the tasks listed in the form 200 could be divided into groups, and a score could be assigned to each group. As a particular example, the tasks listed in the form 200 could be divided into fifths, where tasks in the lowest fifth receive the lowest score and tasks in the upper fifth receive the highest score.

The form 200 may be used to perform various functions in the system 100. For example, multiple supervisors could use the form 200 to identify the point at which the supervisors would stop assigning tasks to a minimally acceptable employee. The scores from all of the supervisors may be averaged. The average score may then be used to set a minimum score that employees performing a particular work activity 114 should meet. Similarly, multiple supervisors could use the form 200 to identify the point at which the supervisors would stop assigning tasks to an ideal employee. The scores from all of the supervisors may be averaged, and the average score may be used to set an ideal score that employees performing a particular work activity 114 should meet.

In addition, a particular supervisor could use the form 200 to identify the point at which the supervisor would stop assigning tasks to a particular employee. The employee's score is then compared to the average minimally acceptable score, the average ideal score, and/or the average exceptional score. The scores could then be used in any suitable manner. For example, employees who fail to meet the minimally acceptable score could be removed from their positions. Employees who fail to meet the ideal score could receive a warning. Employees who exceed the ideal score or meet or exceed the exceptional score could be identified for possible promotion.

By evaluating employees based on the work activities 114 performed by the employees, the performance of employees may be compared even when the employees have different job titles. Also, employees with similar job titles who perform different work activities 114 need not be compared. Further, by averaging the scores assigned to employees by multiple supervisors, baseline requirements for performance may be established. In addition, using a more standard form 200 to evaluate employees may allow performance assessments to become more uniform.

In this particular example, the form 200 is used to evaluate an “Instructing” work activity 114. The tasks identified in the form 200 may represent various tasks 116 associated with the work activity 114. In some embodiments, work activities 114 associated with a job represent skills associated with the job by the Occupation Information Network (O*NET) standard. Also, the O*NET standard may identify the tasks 116 associated with each work activity 114 or skill. Any other work activity 114, task 116, and standard may be used in the form 200 or to generate the form 200.

Although FIG. 2 illustrates one example of a form 200 used to evaluate overall performance of a work activity 114, various changes may be made to FIG. 2. For example, the layout and composition of the form 200 is for illustration only. Forms having other layouts and/or compositions could also be used.

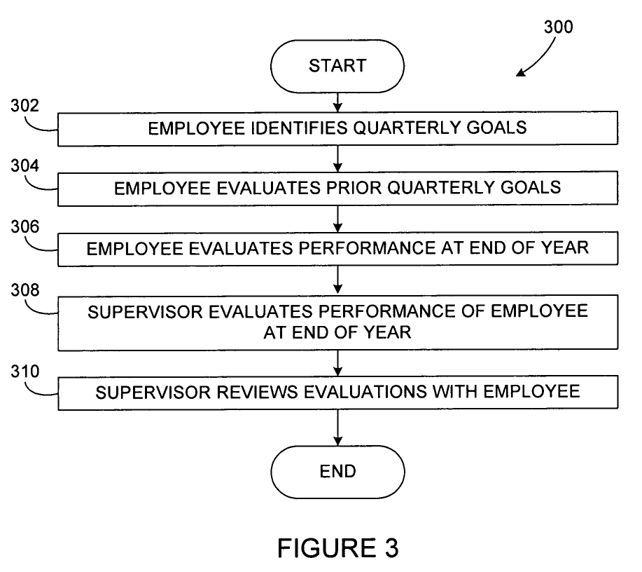

FIG. 3 illustrates an example method 300 for appraising job performance according to one embodiment of this disclosure. For ease of explanation, the method 300 is described with respect to the performance assessment server 106 operating in the system 100 of FIG. 1. The method 300 could be used by any other suitable device and in any other suitable system

The performance assessment server 106 allows an employee to identify one or more quarterly goals at step 302. This may include, for example, the performance assessment server 106 using an electronic form to receive input from the employee identifying the goals. This may also include the performance assessment server 106 providing a printed form that can be filled out by the employee. For each quarterly goal identified, the employee may also identify the work activity 114 that is most closely associated with the goal.

The performance assessment server 106 allows the employee to evaluate the employee's previous quarterly goals at step 304. This may include, for example, the performance assessment server 106 using an electronic form to receive input from the employee identifying how the employee met the previous quarterly goals. This may also include the performance assessment server 106 providing a printed form that can be filled out by the employee. For each previous quarterly goal, the employee may identify the specific tasks or activities that were completed for each of the goals.

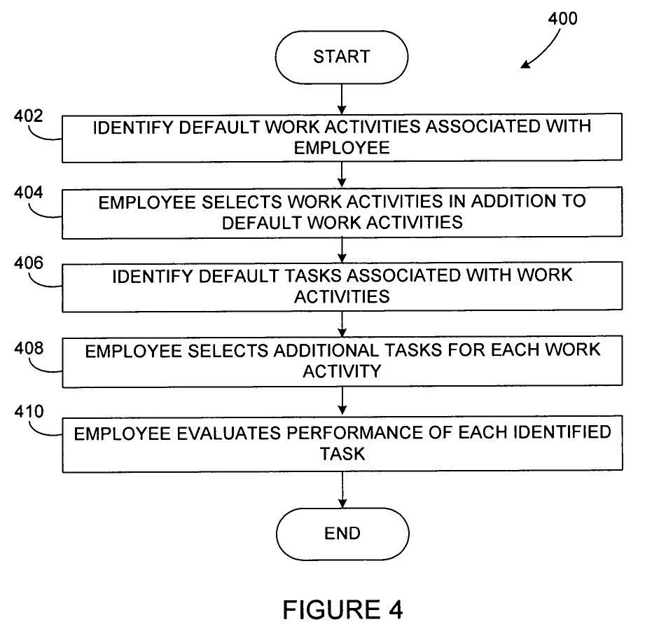

The performance assessment server 106 allows the employee to evaluate his or her job performance at the end of the year at step 306. This may include, for example, the performance assessment server 106 using an electronic form to receive input from the employee, where the input identifies how the employee rates his or her performance at certain tasks 116 and work activities 114. This may also include the performance assessment server 106 providing a printed form that can be filled out by the employee. One example of a method for allowing an employee to perform a self-evaluation is shown in FIG. 4, which is described below.

The performance assessment server 106 allows a supervisor to evaluate the performance of the employee at the end of the year at step 308. This may include, for example, the performance assessment server 106 using an electronic form to receive input from the supervisor, where the input identifies how the supervisor rates the employee's performance at certain tasks 116 and work activities 114. This may also include the performance assessment server 106 providing a printed form that can be filled out by the supervisor. This may further include the performance assessment server 106 providing the supervisor with the quarterly goals, quarterly goal evaluations, and self-evaluation supplied by the employee.

The performance assessment server 106 allows a supervisor to review the evaluations with the employee at step 310. This may include, for example, the performance assessment server 106 providing the various collected information to the supervisor and/or the employee for the review.

Although FIG. 3 illustrates one example of a method 300 for appraising job performance, various changes may be made to FIG. 3. For example, each one of these steps could involve the performance assessment server 106 actively receiving input from a user or passively providing forms for use. Also, the identification of the goals, the evaluation of the goals, and the evaluations of the employee may occur during any suitable time period(s) and are not limited to quarterly or annual periods of time.

FIG. 4 illustrates an example method 400 for performing an employee self-appraisal according to one embodiment of this disclosure. For ease of explanation, the method 400 is described with respect to the performance assessment server 106 operating in the system 100 of FIG. 1. The method 400 could be used by any other suitable device and in any other suitable system

The performance assessment server 106 identifies one or more default work activities 114 associated with the employee at step 402. This may include, for example, the performance assessment server 106 identifying the employee and identifying one or more work activities 114 associated with the employee's job. In particular embodiments, the performance assessment server 106 identifies up to seven work activities 114 associated with the employee.

The performance assessment server 106 allows the employee to select one or more additional work activities 114 at step 404. This may include, for example, the performance assessment server 106 allowing the employee to select work activities 114 that the employee performed over the preceding year. In particular embodiments, the employee is allowed to select up to three additional work activities 114.

The performance assessment server 106 identifies one or more default tasks 116 associated with each of the identified work activities 114 at step 406. This may include, for example, the performance assessment server 106 identifying the tasks 116 associated with each of the default work activities 114 and the work activities 114 identified by the employee. In particular embodiments, the performance assessment server 106 identifies up to ten tasks 116 associated with the work activity 114.

The performance assessment server 106 allows the employee to select one or more additional tasks 116 at step 408. This may include, for example, the performance assessment server 106 allowing the employee to select tasks 116 that the employee performed over the preceding year. In particular embodiments, the employee is allowed to select up to five additional tasks 116 for each of the identified work activities 114.

The performance assessment server 106 allows the employee to evaluate his or her performance of each of the identified tasks 116 at step 410. This may include, for example, the performance assessment server 106 allowing the employee to rank his or her performance of each default task 116 and employee-identified task 116 on a scale.

Although FIG. 4 illustrates one example of a method 400 for performing an employee self-appraisal, various changes may be made to FIG. 4. For example, the employee could be allowed to select any number of additional work activities 114 or any number of additional tasks 116.

It may be advantageous to set forth definitions of certain words and phrases that have been used within this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, software, firmware, or combination thereof. It should be noted that the functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method, comprising:
identifying at least one work activity associated with an employee's job;
allowing the employee to identify at least one additional work activity;
identifying at least one task for each of the identified work activities;
allowing the employee to identify at least one additional task for one or more of the identified work activities; and
allowing the employee to assign a rating to each of the identified tasks, the ratings associated with the employee's performance of the identified tasks.

2. The method of claim 1, wherein:
identifying the at least one work activity comprises identifying up to seven work activities; and
allowing the employee to identify the at least one additional work activity comprises allowing the employee to identify up to three additional work activities.

3. The method of claim 1, wherein:
identifying the at least one task comprises identifying up to ten tasks for each of the identified work activities; and
allowing the employee to identify the at least one additional task comprises allowing the employee to identify up to five additional tasks for each of the identified work activities.

4. The method of claim 1, further comprising:
allowing the employee to identify one or more goals of the employee for a future time period; and
allowing the employee to evaluate one or more goals of the employee for a prior time period.

5. The method of claim 4, further comprising providing the identified goals, the evaluation of the goals, and the ratings to a supervisor of the employee;
wherein the supervisor uses the identified goals, the evaluation of the goals, and the ratings to evaluate the employee.

6. The method of claim 5, wherein the supervisor evaluates the employee by identifying an amount of supervision needed for the employee to complete each of the identified tasks.

7. The method of claim 1, further comprising generating a score for each of the identified work activities, the score generated for one of the identified work activities by averaging the ratings for all of the tasks associated with the work activity.

8. A system, comprising:
one or more processors collectively operable to:
identify at least one work activity associated with an employee's job;
receive from the employee an identification of at least one additional work activity;
identify at least one task for each of the identified work activities;
receive from the employee an identification of at least one additional task for one or more of the identified work activities; and
receive from the employee a rating for each of the identified tasks, the ratings associated with the employee's performance of the identified tasks; and
a memory operable to store the identified work activities, the identified tasks, and the ratings.

9. The system of claim 8, wherein:
the one or more processors are further collectively operable to identify the at least one work activity by identifying up to seven work activities; and
the one or more processors are collectively operable to receive the identification of the at least one additional work activity by receiving an identification of up to three additional work activities.

10. The system of claim 8, wherein:
the one or more processors are further collectively operable to identify the at least one task by identifying up to ten tasks for each of the identified work activities; and
the one or more processors are collectively operable to receive the identification of the at least one additional task by receiving an identification of up to five additional tasks for each of the identified work activities.

11. The system of claim 8, wherein the one or more processors are further collectively operable to:
receive from the employee an identification of one or more goals of the employee for a future time period; and
receive from the employee an evaluation of one or more goals of the employee for a prior time period.

12. The system of claim 11, wherein the one or more processors are further collectively operable to provide the identified goals, the evaluation of the goals, and the ratings to a supervisor of the employee.

13. The system of claim 11, wherein:
the one or more processors are collectively operable to receive the identification of the goals each quarter; and
the one or more processors are collectively operable to receive the ratings annually.

14. The system of claim 8, wherein the one or more processors are further collectively operable to generate a score for each of the identified work activities.

15. A computer program embodied on a computer readable medium and operable to be executed by a processor, the computer program comprising computer readable program code for:
identifying at least one work activity associated with an employee's job;
receiving from the employee an identification of at least one additional work activity;
identifying at least one task for each of the identified work activities;
receiving from the employee an identification of at least one additional task for one or more of the identified work activities; and
receiving from the employee a rating for each of the identified tasks, the ratings associated with the employee's performance of the identified tasks.

16. The computer program of claim 15, wherein:
the computer readable program code for identifying the at least one work activity comprises computer readable program code for identifying up to seven work activities; and
the computer readable program code for receiving the identification of the at least one additional work activity comprises computer readable program code for receiving an identification of up to three additional work activities.

17. The computer program of claim 15, wherein:
the computer readable program code for identifying the at least one task comprises computer readable program code for identifying up to ten tasks for each of the identified work activities; and
the computer readable program code for receiving the identification of the at least one additional task comprises computer readable program code for receiving an identification of up to five additional tasks for each of the identified work activities.

18. The computer program of claim 15, further comprising computer readable program code for:
receiving from the employee an identification of one or more goals of the employee for a future time period; and
receiving from the employee an evaluation of one or more goals of the employee for a prior time period.

19. The computer program of claim 15, further comprising computer readable program code for generating a score for each of the identified work activities, the score generated for one of the identified work activities by averaging the ratings for all of the tasks associated with the work activity.

20. A method, comprising:
receiving an identification of at least one work activity associated with an employee's job;
identifying at least one additional work activity;
receiving an identification of at least one task for each of the identified work activities;
identifying at least one additional task for one or more of the identified work activities; and
assigning a rating to each of the identified tasks, the ratings associated with the employee's performance of the identified tasks.
